(19) United States
(12) Patent Application Publication
(10) Pub. No.: US 2018/0326243 A1
(43) Pub. Date: Nov. 15, 2018

(54) A CABLE-DRIVEN ROBOT FOR LOCOMOTOR REHABILITATION OF LOWER LIMBS

(71) Applicants: École de technologie supérieure, Montreal (CA); THE ROYAL INSTITUTION FOR THE ADVANCEMENT OF LEARNING/MCGILL UNIVERSITY, Montreal (CA)

(72) Inventors: Abdelhak BADI, Brossard (CA); Maarouf SAAD, Montreal (CA); Guy GAUTHIER, Saint-Eustache (CA); Philippe ARCHAMBAULT, Montreal (CA)

(21) Appl. No.: 15/778,901

(22) PCT Filed: Nov. 24, 2016
(86) PCT No.: PCT/CA2016/051376

§ 371 Date: May 24, 2018

Related U.S. Application Data
(60) Provisional application No. 62/259,219, filed on Nov. 24, 2015.

(51) Int. Cl. A63B 21/00; A61H 1/02; A63B 21/005; A63B 22/02; A63B 24/00

(52) U.S. Cl. CPC A63B 21/00181; A63B 2208/0252; A63B 21/00178; A63B 21/0058; A63B 21/153; A63B 21/4015; A63B 21/4034; A63B 22/02; A63B 24/0075; A63B 24/0087; A61H 2201/1207; A61H 2201/14; A61H 2201/1642; A61H 2201/1652; A61H 2201/1659; A61H 2201/5007; A61H 2203/0406; A61H 2203/0456; A61H 2201/5038; A63B 2208/0204; A61H 1/0262

(57) ABSTRACT

A limb rehabilitation device, control method and kit having a platform, a frame, at least three cables and at least three actuators. The platform is for receiving thereon at least a portion of a limb and has at least three fixed cable positioning attachments. Each of actuator end. The cables are directly connected to a corresponding one of the cable positioning attachments at the platform connection end. The actuators are mounted to the frame and are adapted to retract or extend a corresponding one of the cables from the actuator end in a straight line between the platform connection end and the actuator end in order to provide at least three degrees of freedom movement to the platform, according to a rehabilitation protocol.

### CROSS-REFERENCE TO RELATED APPLICATIONS

The present application claims priority of U.S. Provisional Patent Application No. 62/259,219, filed on Nov. 24, 2015, the contents of which are hereby incorporated.

### TECHNICAL FIELD

The present invention relates to the field of cable-driven robots, and more specifically to the field of cable-driven robots for locomotor rehabilitation of lower limbs.

### BACKGROUND

Patients suffering from locomotor or neurological dysfunction can be rehabilitated by reproducing movements that are adapted to reeducate partially or completely an affected body part, such as a lower-limb. One type of lower-limb rehabilitation technique consists of assisting a patient in reproducing a natural gait, Another type of lower-limb rehabilitation technique consists of assisting a patient in reproducing various lower-limb movements soliciting various articulations of the lower-limb.

Body Weight Support Treadmill Training (BWSTT) is a locomotor rehabilitation technique consisting of a patient walking on a treadmill with partial relief of body weight in order to rehabilitate a lower limb of the patient. Over the past years, it has been shown that the BWSTT technique for locomotor rehabilitation of lower limbs provides marked advantages over other conventional techniques. Amongst other, BWSTT allows to reproduce a correct and healthy joint movement pattern; it avoids inhibition of mobility caused by a use of prosthesis; it helps synchronization of the two legs and coordination of the walk cycle phases; and it ensures a large number of repetitions of walk cycles.

Another technique does away with the treadmill and assists a patient from a lying position, a standing position or even a sitting position to reproduce appropriate movements soliciting various joints of the lower-limb for training purposes. Such training of the lower-limb can be desirable for preparing the patient in eventually accomplishing a natural gait or other types of lower-limb movements.

However, current robotic devices for the rehabilitation of locomotion consist in exoskeleton-type robots, which impose torques directly at one or more joints of the patient's limbs. According to studies made in patients with neurological conditions following a stroke or a spinal cord injury, the effectiveness of such an approach on locomotor function is shown to be limited. This may be due to the limited flexibility of exoskeleton robots and the difficulty in fitting them to different patients.

In international patent application number PCT/US2015/026941 to Agrawal et al. there is disclosed a cable-driven rehabilitation system for rehabilitation of movement disorders by gait therapy that is either treadmill-based or walker-based. The system is adapted to apply controlled forces simultaneously and directly to the pelvis, the knee or the ankle joints by activating cables that provide limb-flexing moments with low inertia and friction resistance. As specified in the detailed description at paragraph [0073], the system does not used rigid links and joints in order to avoid concerns about precise alignment of the exoskeleton joints and human joints. The system uses adapters such as cuffs presented in FIG. 2. In one example, the exoskeleton has three adapters: a hip adapter, a thigh adapter and a shank adapter, as presented in FIG. 1A. Cables are routed through each adapter, in the example of FIG. 1A, the hip adapter has spaced apart guides to allow the passing of respective cables connected to the thigh adapter and the shank adapter. As further explained in paragraph [0082] of the detailed description, a same cable that terminates at the shank adapter passes through a guide of the thigh adapter so as to apply moments to the shank adapter. Each cable has a respective tension sensor and the sensor generates a signal to permit the motion of the attached limbs of the user to be detected and thereby apply assist-as-needed control of the motion of the user limbs, as described at paragraphs [0080] and [0086]. The cables are activated by respective winches that are driven by a motor placed on a frame as detailed at paragraph [0087]. However, since the adapters are activated by cables that pass through guides of the thigh adapter or hip adapter, the motion range of the limb is restricted. This limits the possible range of therapeutic exercises that can be applied to the limb. Moreover, this system applies an assist-as-needed control of the limb's motion and is not adapted for people that do not have the capacity to perform a minimal gait movement of their limb on their own let alone the capacity to stand.

Therefore, there is a need for a device for locomotor rehabilitation adapted for BWSTT and also adapted for other types of locomotor rehabilitation techniques that are effective without hindering limb movements for reproducing various rehabilitation movements in order to restore or perfect a natural gait or even a specialized gait in a human without necessitating a patient to have the capacity to stand or to perform a minimal gait on his own. Moreover, there is a need for a device for locomotor rehabilitation that can easily be fitted to various patients and that can be reconfigured according to a rehabilitation protocol, while remaining simple to manufacture.

### SUMMARY

In accordance with one aspect, there is a limb rehabilitation device having a platform, a frame, at least three cables and at least three actuators. The platform is for receiving thereon at least a portion of a limb. The platform has at least three fixed cable positioning attachments. Each of the cables have a platform connection end and an opposite actuator end, and each of the cables are directly connected to a corresponding fixed cable positioning attachment of the platform at the platform connection end. Each of the actuators are mounted on the frame and are adapted to extend or retract a corresponding one of the cables from the actuator end in a straight line between the platform connection end and the actuator end and provide at least three degrees of freedom movement to the platform, according to a rehabilitation protocol.

In accordance with another aspect, there is a method of controlling a limb rehabilitation device by receiving a patient morphology parameter and receiving an exercise command parameter according to a rehabilitation protocol. The method further determines a trajectory according to the patient morphology parameter and the exercise command parameter and controls an actuation system according to the trajectory. The method further includes suspending the platform with at least three controllable links in order to provide at least three degrees of freedom to the platform. Accordingly, the method further includes actuating by extending or retracting at least one controllable link and thereby displacing at least one portion of the platform.

In accordance with yet another aspect, there is a limb rehabilitation device kit having a longitudinal platform, at least three cables and at least three actuators. The platform is adapted to receive and support at least a portion of a limb. The platform has at least three fixed cable positioning attachments. The cables are adapted to connect to one of the fixed cable positioning attachments of the platform. The actuators are adapted to drive the cables.

### BRIEF DESCRIPTION OF THE DRAWINGS

Further features and advantages of the present invention will become apparent from the following detailed description, taken in combination with the appended drawings, in which:

FIG. 1 presents a lower limb rehabilitation cable-driven robot having a platform for receiving a lower limb of a patient in a vertical position and being adapted to be actuated by an actuation system, according to one embodiment;

FIG. 2 presents the cable-driven robot of FIG. 1 mounted on a base frame, according to embodiment;

FIG. 3A presents a parameter diagram for a model of the cable-driven robot of FIG. 2;

FIG. 3B presents a diagram of cable forces exerted on the platform of the cable-driven robot of FIG. 1;

FIG. 4 presents a lower-limb model of a patient indicating various associated articulation rotation parameters, according to one embodiment;

FIG. 5 presents a lower-limb model of a patient indicating various associated member length parameters, according to one embodiment;

FIG. 6 presents a lower-limb model of a patient as it is being driven by the platform of FIG. 1, according to one embodiment;

FIG. 7 presents a lower-limb model of a patient as it is being driven by the platform of FIG. 1, according to one embodiment;

FIG. 8 presents a lower limb rehabilitation cable-driven robot having a platform for receiving a lower limb of a patient in a horizontal position and being adapted to be actuated by an actuation system, according to one embodiment;

FIG. 9 presents the cable-driven robot of FIG. 8 mounted on a base frame, according to embodiment;

FIG. 10 presents a parameter diagram of the cable-driven robot of FIG. 9;

FIG. 11 presents a diagram of cable forces exerted on the platform of the cable-driven robot of FIG. 8;

FIG. 12 presents a block diagram of a method for controlling the lower limb rehabilitation cable-driven robot of FIGS. 1 and 8;

FIG. 13 presents a block diagram of the control system of the lower limb rehabilitation cable-driven robot of FIGS. 1 and 8; and

FIGS. 14A and 14B present various components of a lower limb rehabilitation cable-driven robot device kit.

It will be noted that throughout the appended drawings, like features are identified by like reference numerals.

### DETAILED DESCRIPTION

### Vertical Position Configuration

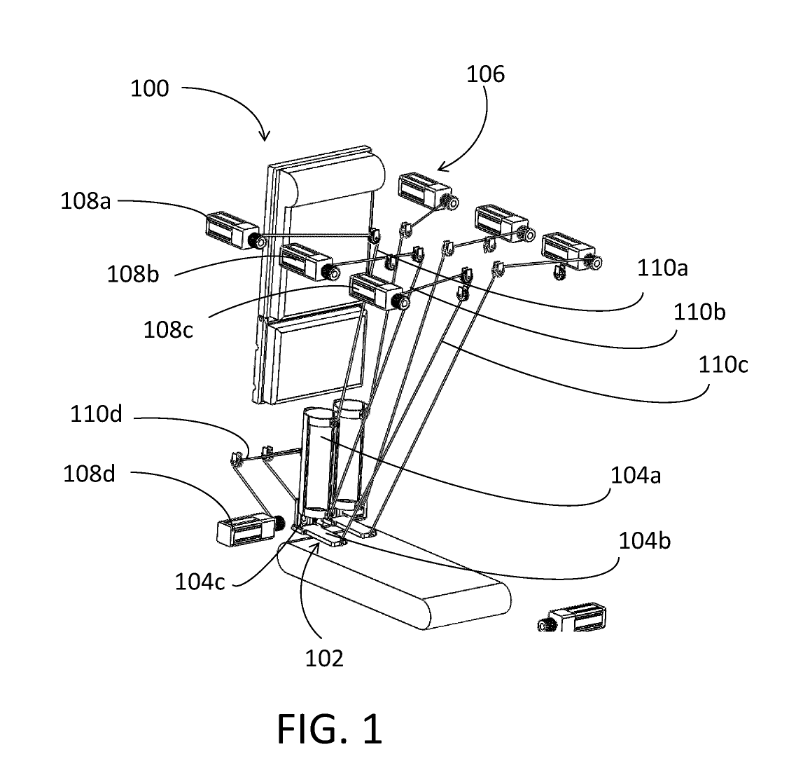

Presented in FIG. 1 is a cable-driven robot 100 adapted to assist a patient in performing physical exercises in a vertical position such as a standing position. The cable-driven robot 100 is adapted to guide a patient in reproducing lower limb movements according to a rehabilitation protocol by soliciting a hip joint, a knee joint or an ankle joint. The cable-driven robot 100 presented in FIG. 1 is in a standing position configuration in order to allow a patient to be rehabilitated according to a vertical position and reproduce, in some cases, a natural gait or at least a portion of a natural gait.

The cable-robot 100 of FIG. 1 is adapted to achieve a flexion-extension of the hip, knee and ankle in at least one leg of the patient. According to one embodiment and as presented in FIG. 1, the cable-robot 100 has two platforms 102 or orthosis adapted to receive a left and right leg of a patient. Each platform 102 has a lower leg segment 104a adapted to receive a lower leg (i.e. part of a lower limb between knee and ankle) of a patient and a foot segment 104b that is adapted to receive a foot of a patient. Notice that each platform has three degrees of freedom. The lower leg segment 104a and the foot segment 104b are pivotally joined, such as with a passive rotary joint 104c, thereby accommodating movements of the patient's ankle joints independently of the other articulations. In use, a patient may mount the platform by placing his lower leg onto the lower leg segment 104a and by placing his foot onto the foot segment 104b and perform longitudinal movements in the X-Y plane and rotational movements around the Z axis, according to a rehabilitation protocol.

Notice that the segments 104a and 104b have a longitudinal shape adapted to supportively receive thereon a limb of the patient.

Since each platform is made of two segments interconnected by a passive rotary joint, the robot 100 is adapted to provide a trajectory composed of two independent motions. It shall however be understood that in some cases a trajectory composed of two independent motions can be undesirable and that the passive rotary joint is replaceable by a non-passive rotary joint or by a fixed joint depending on the rehabilitation protocol.

According to one embodiment and as further presented in FIG. 1, each platform 102 has an associated actuation system 106. The actuation system 106 has four actuators 108a, 108b, 108c, 108d and corresponding cables 110a, 110b, 110c, and 110d, in order to either control a longitudinal movement of the platform in the X-Y plane or a rotational movement of the platform in the Z axis. Each of the four actuators is adapted to provide an extension or a retraction of a corresponding cable by unwinding or winding the cable according to a control command for producing a desired movement of the platform 102, without restriction according to the articulatory movements of a human being.

In FIG. 1, the actuators 108a, 108b, 108c and 108d each have a cable reel mounted on a respective motor. The cable reel can be directly mounted on the motor or via a gearbox.

As further presented in FIG. 1, in the standing position configuration, the actuator 108a, is adapted to drive a below knee portion of the lower leg segment 104a via cable 110a that is connected to proximal end of the lower leg segment. The actuator 108b, is adapted to drive an above ankle portion of the lower leg segment 104a via cable 110b that is connected to a distal end of the lower leg segment 104a. The actuator 108c, is adapted to drive the foot segment via cable 110c that is connected at a distal end of the foot segment. The actuator 108d, is adapted to drive a middle portion of the lower leg segment 104a via cable 110d that is connected to a middle portion of the lower leg segment 104a. The actuation system 106 is therefore adapted to ensure a coordinated and synchronized movement of the platform 102 by winding or unwinding specific cables according to a rehabilitation protocol, without restriction according to the articulatory movements of a human being.

It shall be understood that the cable-robot 100 is adapted to guide the patient in reproducing lower limb movements according to a rehabilitation protocol soliciting a single limb (i.e. either a left limb or a right limb) or both limbs at once. Therefore, although the present cable-robot 100 is adapted to solicit both limbs of the patient at once, it shall be understood that the cable-robot 100 can have a reduced set of actuators and cables to guide only a single platform 102. Moreover, although the present cable-robot 100 is adapted to solicit a hip joint, a knee joint and an ankle joint independently or as a combination thereof, it shall be noted that the cable-robot 100 can have a reduced set of actuators and cables to solicit only a single joint or a single combination of joints.

According to one embodiment, the cable-robot 100 has a treadmill 112 to facilitate a walking motion of the lower limbs such for Body Weight Support Treadmill Training (BWSTT). It shall however be noticed that for certain lower-limb exercises, the treadmill 112 is not required and the cable-robot 100 can be positioned directly on a fixed floor or any other suitable surface.

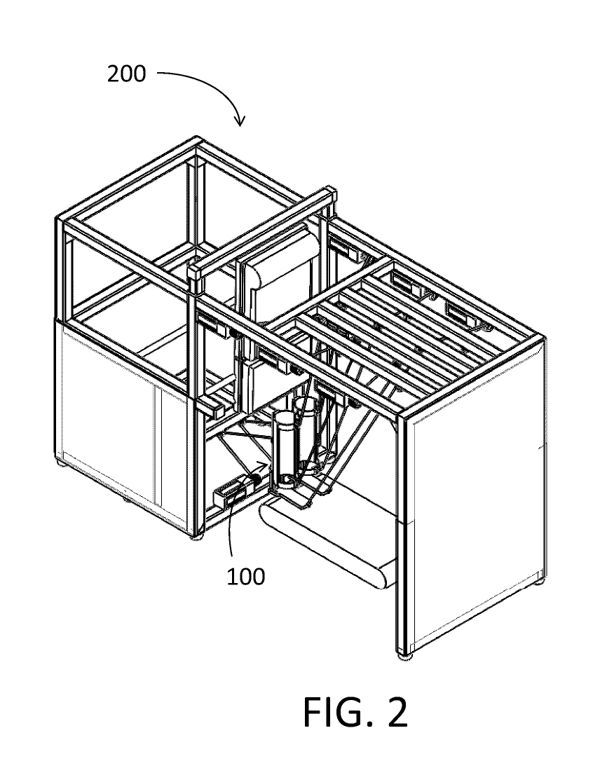

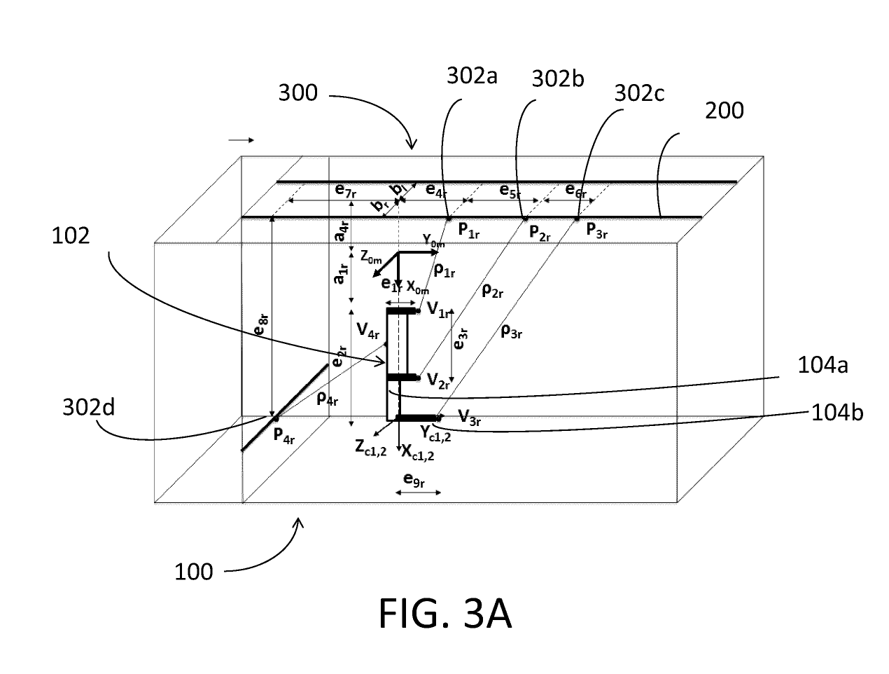

Presented in FIG. 2 according to one embodiment, the cable-robot 100 is attached to a base frame 200. The base frame 200 is adapted to support the cable-robot 100 by providing suitable anchoring of the actuators 108a, 108b, 108c and 108d and corresponding cable guides 302a, 302b, 302c and 302d. The cable guides 302a, 302b, 302c and 302d are strategically positioned according to the platform and associated cable lengths, as concurrently presented in FIG. 3A.

According to one embodiment and as further presented in FIG. 2, the position and the orientation of the platform segments 104a and 104b are determined according to the length of each cable 110a, 110b, 110c and 110d. Presented in FIG. 3A is a parameter diagram 300 for a model of the cable-robot 100, various parameters are identified such as a cable length, a lower leg segment and a foot segment length, and a cable guide positioning with respect to the base frame 200. In the diagram 300, the lengths of the cables 110a, 110b, 110c and 110d are identified respectively as variables ρ₁ₖ, ρ₂ₖ, ρ₃ₖ and ρ₄ₖ. The length ρⱼₖ of cable j of the side k (r: right or l: left) is the distance between its attachment point Pⱼₖ at the base frame 200 and the attachment point Vⱼₖ on the platform.

Each cable 110a, 110b, 110c and 110d is passed through the respective cable guide 302a, 302b, 302c and 302d such as a pulley of radius rⱼₖ, where jϵ{1,2,3,4} and k identifies a right and left side.

FIG. 3B presents the cable forces on the platform 102, in the standing position configuration, as produced by the actuation system 106 via cables 110a, 110b, 110c and 110d, as concurrently presented in FIG. 1.

Each platform is divided in two parts, such as the lower leg segment 104a and the foot segment 104b articulated around the passive rotary joint. In task space, the robot 100 is adapted to produce a translation and rotation movement of the entire platform 102 and also produce a rotation of the foot segment 104b relative to the lower leg segment 104a, without restriction according to the articulatory movements of a human being.

Both segments 104a and 104b are adapted to produce a translation in their X-Y plane and a rotation around their Z axis. The reference frames {X_{c1},Y_{c1},Z_{c1}} and {X_{c2},Y_{c2},Z_{c2}}, of both segments 104a and 104b, are located at the rotary joint with their origin at the same location and the Z axis in the same direction.

Notice that FIG. 3A shows a single platform, in order to have a clearer picture of the diagram 300. An opposite platform would be placed symmetrically at distance bₗ from the base frame 200.

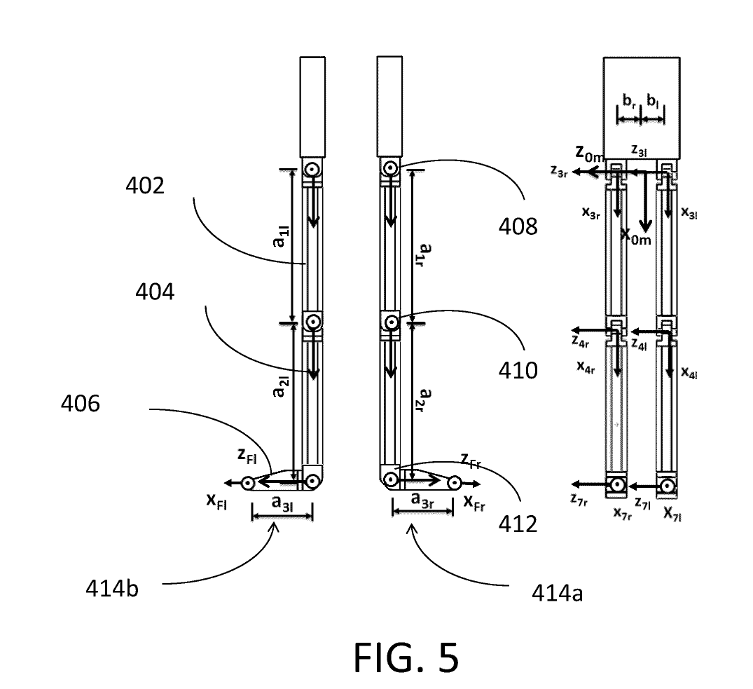

According to one embodiment, the parameters of the cable-driven robot 100 having a right platform 102, as presented in FIGS. 3A and 5, are set to the following values in meters: a1r=0.44 m; a2r=0.52 m; a3r=0.24 m; a4r=0.69 m; br=0.17 m; b1=0.17 m; e1r=0.06 m; e2r=0.52 m; e3r=0.41 m; e4r=0.96 m; e5r=0.35 m; e6r=0.25 m; e7r=0.53 m; e8r=1.47 m and e9r=0.24 m. Corresponding parameter values are set, in the case of the cable-robot 100 having an additional left platform 102. It shall be understood that some parameter values are set according to a corresponding body member shape or dimension of the patient. Accordingly, parameters a1k, a2k, a3k and e9k can be variable from one patient to another. Moreover, it shall be understood that the above mentioned parameter values can vary from one rehabilitation protocol to another, depending on the movement amplitudes.

According to one embodiment, the cable-robot 100 of FIG. 3A has cable guides that are attached to the following (Pᵢₓ, P_{iy}, P_{iz}) positions with respect to a base reference (X₀,Y₀,Z₀):

P_{1K}=[−a₄ₖ,e₄ₖ,bₖ]; P_{2K}=[−a₄ₖ,e₄ₖ+e₅ₖ,bₖ];

P_{3K}=[−a₄ₖ,e₄ₖ+e₅ₖ+e₆ₖ,bₖ]; P_{4K}=[e₈ₖ−a₄ₖ,−e₇ₖ,bₖ].

In addition, each corresponding cable is attached to an associated lower-leg segment 104a or foot segment 104b at cable attachment points Vᵢ with respect to the associated segment reference (X_{c1},X_{c1},Z_{c1}) or (X_{c2},Y_{c2},Z_{c2}):

V_{1K}=[−e₂ₖ,e₁ₖ/2,0]; V_{2K}=[e₃ₖ−e₂ₖ,e₁ₖ/2,0];

V_{3K}=[−e₉ₖ sin(θ₇ₖ),e₉ₖ cos(θ₇ₖ)−e₁ₖ/2,0]; V_{4K}=[e₃ₖ/2−e₂ₖ,−elk/2,0].

### Kinematic Model of Lower Limb

According to another aspect, a lower-limb model is used as a reference in order to allow a clinician to define desired movements and also to validate the behavior of the cable-robot 100. This is done by comparing positions and orientations of several reference points of the model with respective reference points of the platform 102, as concurrently presented in FIG. 1.

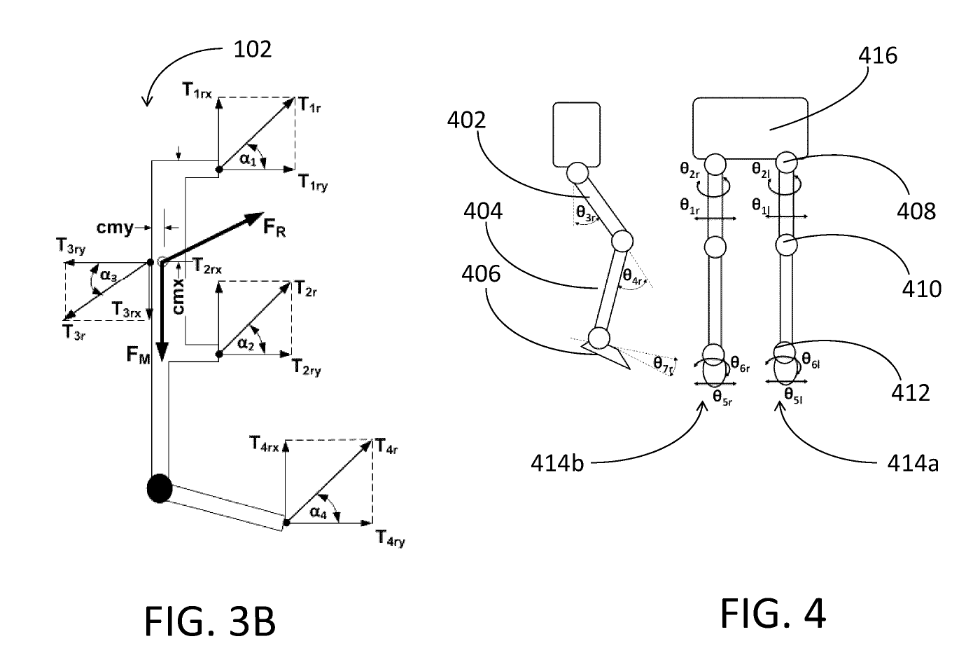

According to one embodiment, presented in FIG. 4 is a lower limb model 400 indicating various associated articulation rotation parameters. Presented in FIG. 5 is a lower limb model 500 indicating associated member length parameters. The articulation rotation parameters and the member length parameters are variable from one patient to another and can also be influence by the rehabilitation protocol. Those parameters are therefore carefully taken into consideration and determined in order to suitably configure the cable-robot 100, on a case by case basis.

In FIG. 4, the leg segments are represented as a mechanical system with two parallel kinematic open chains, each formed of three rigid segments: thigh 402, lower leg 404 and foot 406 and three rotary joints: hip 408, knee 410 and ankle 412.

The lower-limbs of a patient are modelled as two parallel kinematic chains 414a and 414b linked to a rigid frame 416. Each of these kinematic chains 414a and 414b is composed of three segments 402,404 and 406 and three joints 408, 410 and 412, as presented in FIG. 4A. It is the flexion and extension movements of those three joints 408, 410 and 412 that is being considered. The reference frame is placed at the midpoint between the two joints 408 of the hip. The Z₀ axis is oriented in the same direction as Z₃ᵣ, as concurrently presented in FIG. 5. The present kinematic model uses the Denavit-Hartenberg convention. The table below describes the segment parameters for each kinematic chain 414a and 414b.

| joint | αₖ | aₖ | dₖ | θₖ |
|---|---|---|---|---|
| 3 | 0 | 0 | bₖ | θ₃ₖ |
| 4 | 0 | a₁ₖ | 0 | θ₄ₖ |
| 7 | 0 | a₂ₖ | 0 | θ₇ₖ + π/2 |

Since there is symmetry between the two kinematic chains 414a and 414b, subscript k is used in the equations. This subscript is replaced by r in the equations concerning the right kinematic chain 414a. The subscript l refers to the left kinematic chain 414b. The distance bₖ is replaced by bᵣ for the right side and −bₗ for the left side.

According to one embodiment, the rehabilitation movements considered are with respect to joints 408, 410 and 412 rotating according to θ₃ₖ, θ₄ₖ or θ₇ₖ and the movements of the leg is restricted to the X-Y plane (i.e sagittal plane), as presented in FIG. 4.

A skilled person will understand that in other instances, as further presented in FIG. 4, the rehabilitation movements considered can be with respect to joints 408, 410 and 412 rotating according to θ₁ₖ, θ₂ₖ, θ₅ₖ or θ₆ₖ using another cable-robot configuration, without departing from the scope of the present cable-robot 100.

According to one embodiment and further referring to FIG. 4, the direct and inverse kinematics of the leg segments 402, 404 and 406 and their desired velocities and accelerations is determined. The inverse and differential kinematics of the cables 110a, 110b, 110c and 110d is also determined according to the relationship between desired physiological joints angle (θ₃ₖ, θ₄ₖ or θ₇ₖ) and the cable reel drum angle (α₁ₖ, α₁ₖ, α₃ₖ, α₄ₖ), as concurrently presented in FIG. 3.

### Physiological Members Kinematic

Further referring to FIG. 4, the direct kinematic of both chains 414a and 414b are defined by the following homogeneous transformation matrix:

$$\begin{matrix}{}_{7 k}^{0} H = {}_{3 k}^{0} H {}_{4 k}^{3 k} H {}_{7 k}^{4 k} H \\ = [ \begin{matrix}- {s}_{3 k + 4 k + 7 k} & - {c}_{3 k + 4 k + 7 k} & 0 & {a}_{2 k} {c}_{3 k + 4 k} + {a}_{1 k} {c}_{3 k} \\ {c}_{3 k + 4 k + 7 k} & {s}_{3 k + 4 k + 7 k} & 0 & {a}_{2 k} {s}_{3 k + 4 k} + {a}_{1 k} {s}_{3 k} \\ 0 & 0 & 1 & {b}_{k} \\ 0 & 0 & 0 & 1\end{matrix} ]\end{matrix} \qquad ( 1 )$$

where s. and c. correspond respectively to sin(⋅) and cos(⋅).

At the end of the kinematic chain k (recall that k is r or l—right or left), the direct kinematics is given by:

$$\begin{matrix}{}_{Fk}^{0} H = {}_{7 k}^{0} H {}_{Fk}^{7 k} H \\ = [ \begin{matrix}- {s}_{3 k + 4 k + 7 k} & - {c}_{3 k + 4 k + 7 k} & 0 & {β}_{1} \\ {c}_{3 k + 4 k + 7 k} & {s}_{3 k + 4 k + 7 k} & 0 & {β}_{2} \\ 0 & 0 & 1 & {b}_{k} \\ 0 & 0 & 0 & 1\end{matrix} ]\end{matrix} \qquad ( 2 )$$

where β₁=−a₃ₖS₃ₖ₊₄ₖ₋₇ₖ+a₂ₖc₃ₖ₊₄ₖ+a₁ₖc₃ₖ and β₂=−a₃ₖc₃ₖ₊₄ₖ₋₇ₖ+a₂ₖs₃ₖ₊₄ₖ+a₁ₖs₃ₖ.

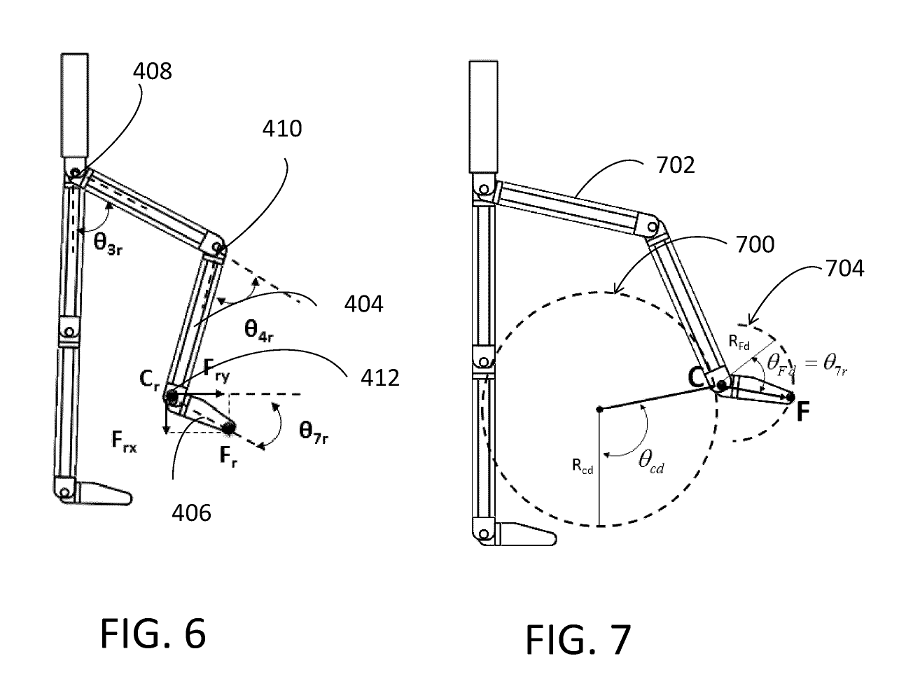

FIG. 6 presents rotational movements of joints 408, 410 and 412 of the lower-limb 600 being driven by the platform 102. Notice that the independent rotational movement of the ankle joint 412 is produced by the independent relationship between the movements of the foot segment 406 and the movements of the lower leg segment 404.

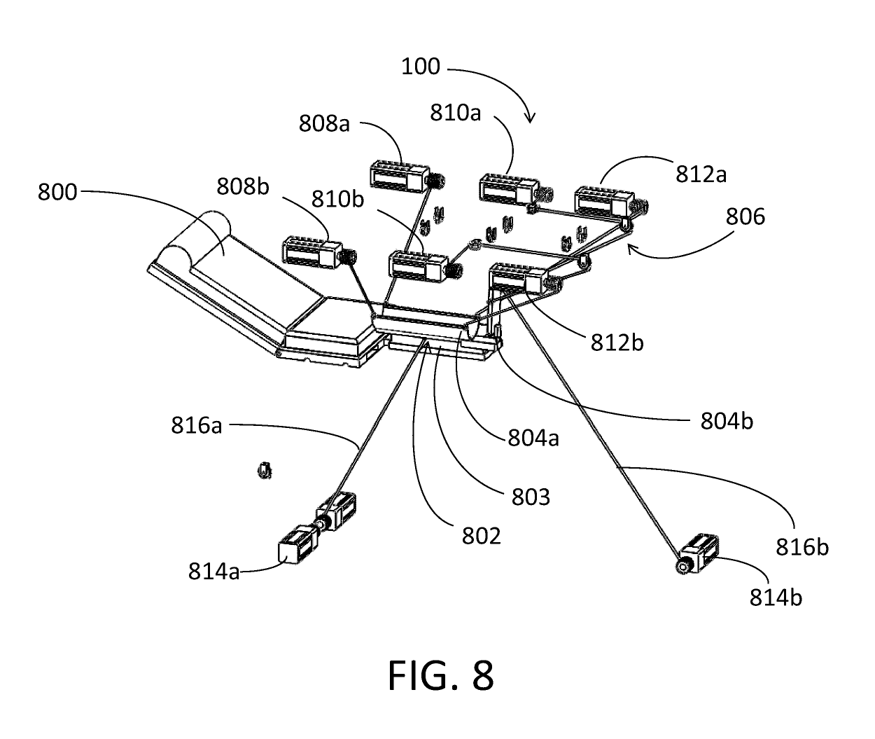

According to one embodiment, FIG. 7 presents a circular trajectory 700 of a lower-limb 702 being guided by the cable-robot 100 without necessarily requiring a treadmill, as concurrently presented in FIG. 1. The circular trajectory 700 defines a radius R_{cd} at point Cᵣ, where θ_{cd} goes from 0 to 2π while the foot maintains an orientation having an angle 704 (θ_{Fd}=θ₇ᵣ+π/2).

### Horizontal Position Configuration

According to another aspect, the cable-driven robot 100 is configured to allow a patient to be rehabilitated in a horizontal position such as a supine position, in order to allow rehabilitation of a patient while lying with the face up and fully support the patient. The supine position configuration may be better adapted for rehabilitating a lower limb of a patient having severe neurological conditions and that is unable to actively move his own limb. Moreover, the supine position may be preferred for rehabilitating a patient according to a rehabilitation protocol that requires lateral movement of the lower limb. However in some instances, it might be desirable to perform rehabilitation movements while the patient is lying in a prone position (i.e. lying with the face down) or side position (i.e. lying on a side). The cable-driven robot 100 is configurable to allow such prone position or side position exercise movements, as well, while fully supporting the patient.

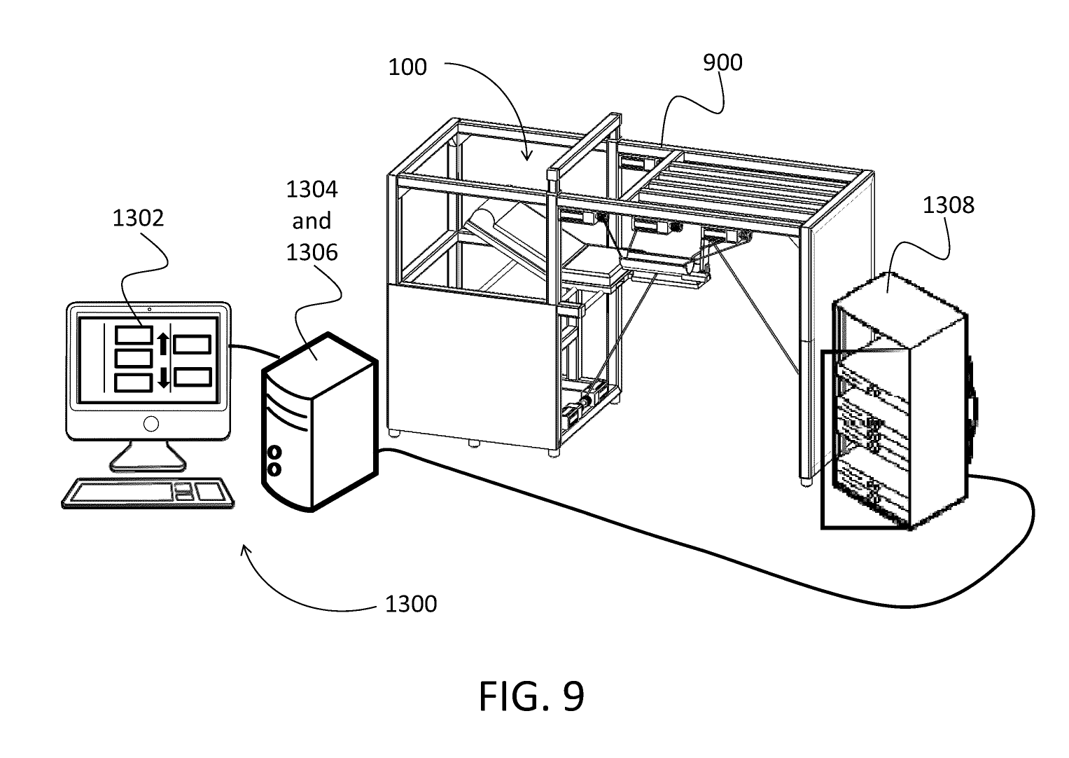

Presented in FIG. 8, according to one embodiment, the cable-robot 100, is adapted to guide the patient in reproducing lower limb movement according to a rehabilitation protocol by soliciting a single limb. The cable-robot 100 has table 800 positioned to support an upper body portion of a lying patient in a supine position while placing one limb to be rehabilitated on a platform 802 and placing the opposite limb on a fixed limb support 803, if required. The platform 802 has a lower leg segment 804a and a foot segment 804b that are pivotally joined such as with a passive rotary joint or a spherical rotary joint. The lower leg segment 804a is adapted to receive a lower leg of the patient and the foot segment 804b is adapted to receive a foot of the patient. An actuation system 806 is adapted to drive the platform 802 in order to perform a translation movement in the X-Y, Y-Z and X-Z planes and rotational movements around the X, Y and Z axes, according to a rehabilitation protocol, without restriction according to the articulatory movements of a human being.

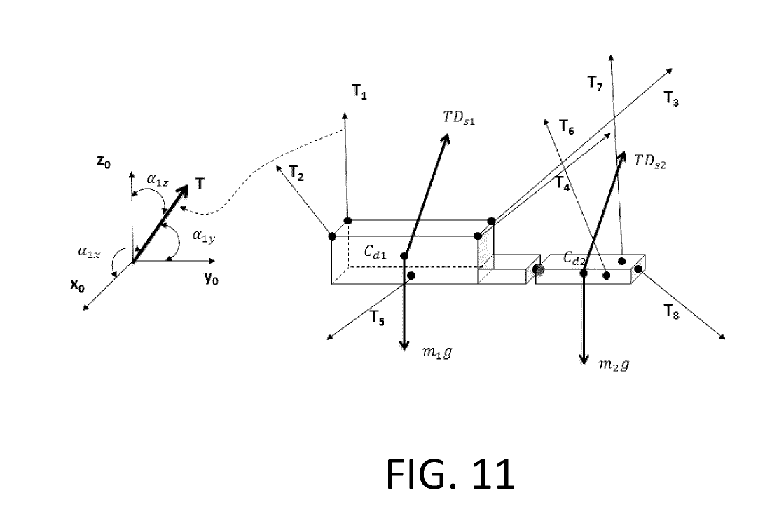

As presented in FIG. 8, the actuation system 806 has a first pair of actuators 808a and 808b, a second pair of actuators 810a and 810b and a third pair of actuators 812a and 812b, in order to provide a movement to the segments 804a or 804b. The first pair of actuators 808a and 808b are adapted to drive a proximal end of the lower leg segment 804a (V1 and V2 of FIG. 10) via associated cables. The second pair of actuators 810a and 810b are adapted to drive a distal end of the lower leg segment 804a (V3 and V4 of FIG. 10) via associated cables. The third pair of actuators 812a and 812b are adapted to drive a distal end of the food segment 804b (V6 and V7 of FIG. 10) via associated cables.

For instance, in order to guide a patient to reproduce an abduction movement or an abduction movement of the lower-limb all five cables associated to the lower-leg segment 804a are operated to drive the segment 804a accordingly. Moreover, in order to guide a patient to reproduce an internal or an external rotation of the ankle all three cables associated to the foot segment 804b are operated to drive the segment 804b accordingly.

It shall be understood that the actuation system 806 can have a reduced number of actuators and associated cables, when only a restricted number of lower limb movements need to be performed, without departing from the cable-robot 100. For instance, the first pair of actuators can be replaced by a single actuator and/or the second pair of actuators can be replaced by a single actuator and/or the third pair of actuators can be replaced by a single actuator. Moreover, a given pair of actuators, such as the third pair of actuators can be removed, without departing from the cable-robot 100.

Further presented in FIG. 8, the actuation system 806 has a lower leg stabilization actuator 814a and foot stabilization actuator 814b. The lower leg stabilization actuator 814a is adapted to stabilize the lower leg segment 804a via associated cable 816a that is attached to a middle section of the lower leg (V5 of FIG. 10). In operation, the lower leg stabilization actuator 814a is adapted to retract the cable 816a in order to pull the lower-leg segment towards a rear. The foot stabilization actuator 814b is adapted to stabilize the foot segment 804b via associated cable 816b that is attached to a distal end of the foot segment 804b (V8 of FIG. 10). In operation, the foot stabilization actuator 814b is adapted to retract the cable 816b in order to pull the foot segment 804b towards the ground.

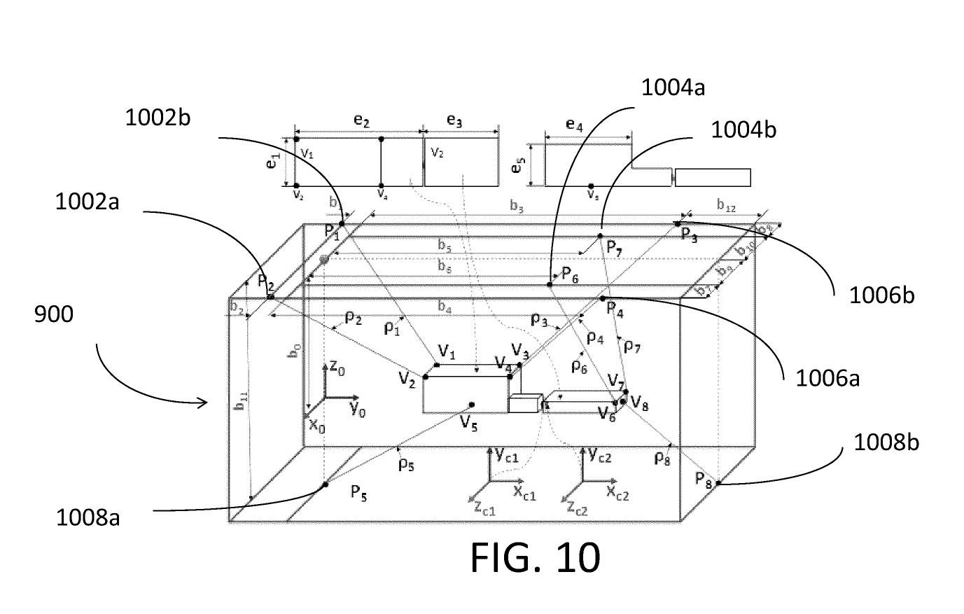

Presented in FIG. 9 according to one embodiment, the cable-robot 100 is attached to a base frame 900. The base frame 900 is adapted to support the cable-robot 100 by providing suitable anchoring of the actuators 808a, 808b, 810a, 810b, 812a, 812b, 814a and 814b and corresponding cable guides 1002a, 1002b, 1004a, 1004b, 1006a, 1006b, 1008a and 1008b at P1, P2, P3, P4, P5, P6, P7, P8 positions of the base frame 900. The cable guides are strategically positioned according to the platform and associated cable lengths, as concurrently presented in FIG. 10.

According to one embodiment, the cable-robot 100 of FIG. 8 has cable guides that are attached to the following (Pᵢₓ, P_{iy}, P_{iz}) positions with respect to a base reference (X₀,Y₀,Z₀):

P₁=[−b₁₀−b₈,−b₁,b₀]; P₂=[b₇±b₉,−b₂,b₀];

P₃=[−b₁₀−b₈,b₃,b₀]; P₄=[b₇+b₉,b₄,b₀];

P₅=[0,0,b₀−b₁₁]; P₆=[b₉,b₆,b₀];

P₇=[−b₁₀,b₅,b₀]; P₈=[0,b₃+b₁₂,b₀−b₁₁].

In addition, each corresponding cable is attached to an associated lower-leg segment 804a or foot segment 804b at cable attachment points Vᵢ with respect to the associated segment reference (X_{c1},Y_{c1},Z_{c1}) or (X_{c2},Y_{c2},Z_{c2}):

V₁=[−e₂,e₅,−e₁/2]; V₂=[−e₂,e₅,e₁/2];

V₃=[e₄−e₂,e₅,−e₁/2]; V₄=[e₄−e₂,e₅,e₁/2];

V₅=[−e₂/2,0,0]; V₆=[e₃,0,e₁/2];

V₇=[e₃,0,−e₁/2]; V₈=[e₃,0,0].

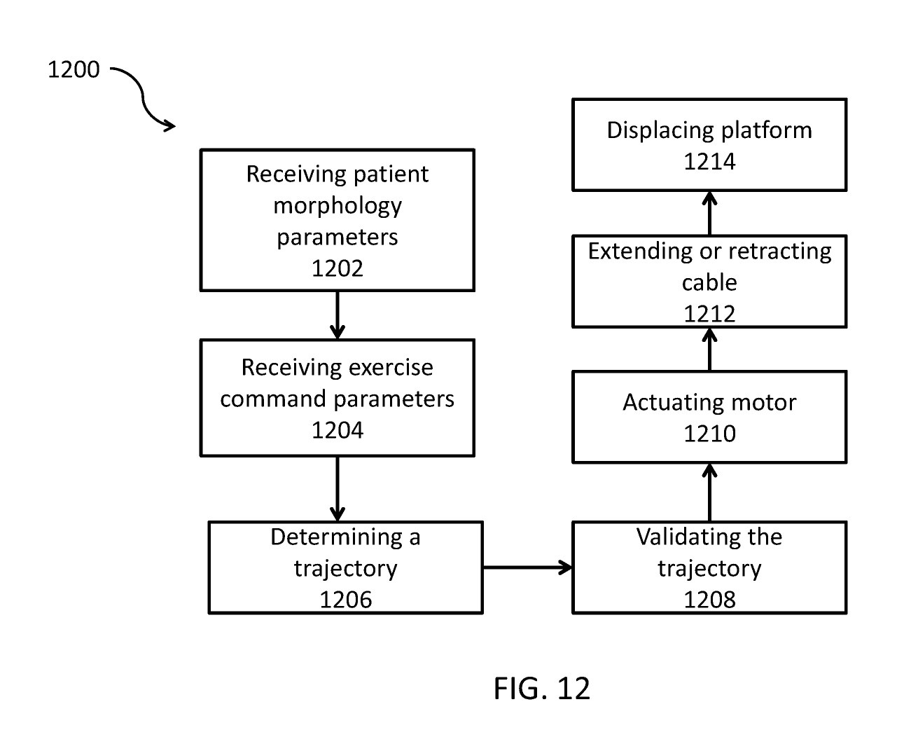

FIG. 11 presents the cable forces on the platform 102, in the supine position configuration, as produced by the actuation system 806 via associated cables as concurrently presented in FIG. 8.

### Method of Controlling a Limb Rehabilitation Device

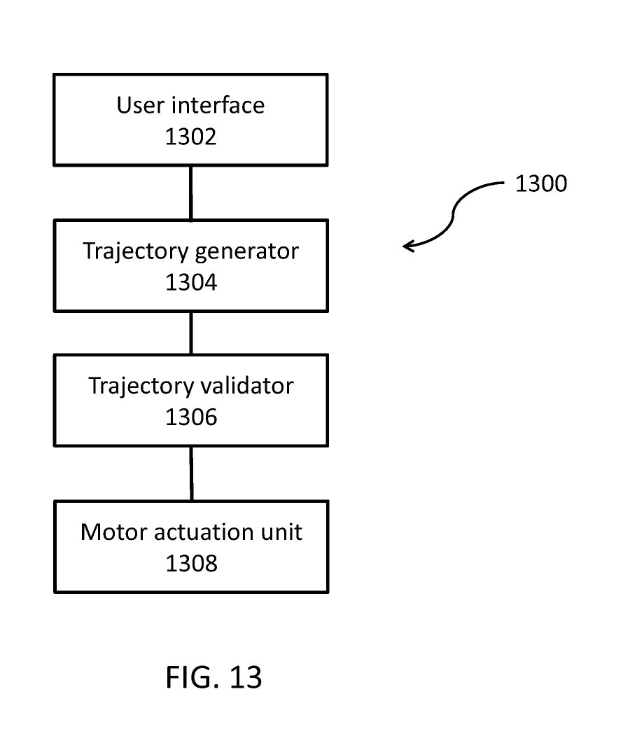

Presented in FIG. 12 is a method of controlling the limb rehabilitation device 1200, according to one embodiment. The method 1200 consists of receiving patient morphology parameters 1202 in order to adapt exercise movements according to the patients anatomical characteristics. The method further consists of receiving exercise parameters 1204, the exercise parameters could be predetermined parameters or parameters that are defined by a clinician. The method further consists of determining a trajectory 1206 according to the patient morphology parameters and the exercise parameters. For safety purposes, the trajectory is validated or modified 1208 in order to verify or assure that the movement provided by the trajectory is physically possible for the patient to carry out. Once verified, the required motors are actuated 1210 in order to extend or retract the required cables 1212 and displace the associated platform 1214 to perform the trajectory.

### Control System to Control the Limb Rehabilitation Device

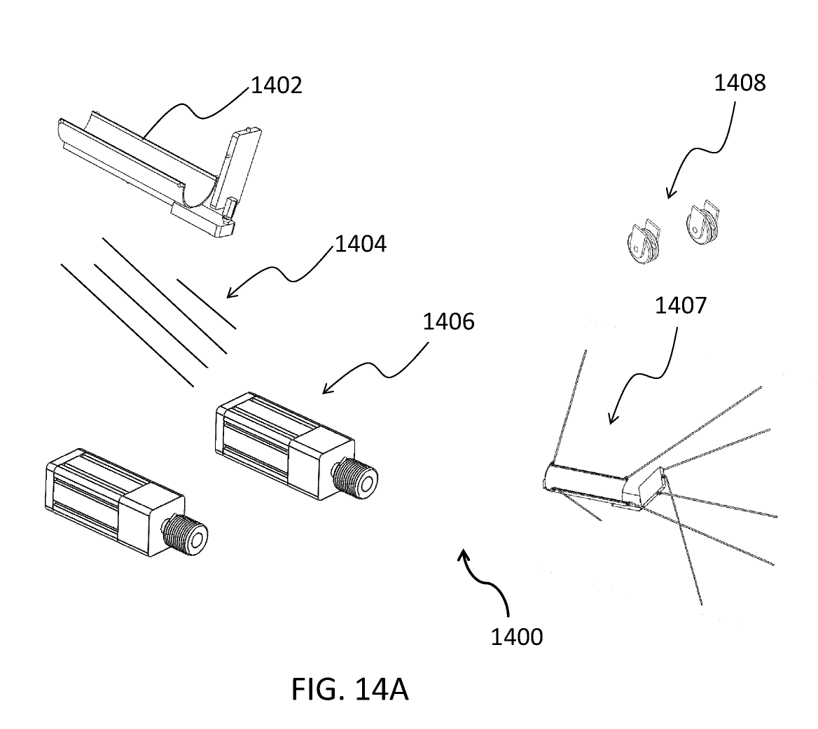

According to one embodiment, there is a control system 1300 adapted to control the limb rehabilitation device 1200 as presented in FIG. 13. The control system 1300 has a user interface 1302, a trajectory generator 1304, a trajectory validator 1306 and a motor actuation unit 1308. The user interface 1302 is adapted to receive patient morphology parameters and exercise parameters that could be entered by the clinician. The trajectory generator 1304 is adapted to generate a trajectory according to the patient morphology parameters and exercise parameters. The trajectory validator 1306 is adapted to verify or modify the trajectory generated in order to assure that the patient is physically capable of performing the trajectory. The motor actuation unit 1308 is adapted to actuate the required motors in order to allow the limb rehabilitation device 1200 to perform the trajectory.

According to one embodiment, as presented in FIG. 9, the control system 1300 is connected to the cable-robot 100. The control system 1300 has a monitor for displaying the user interface 1302. The monitor is connected to a computer having stored a user interface execution module for controlling the user interface and receiving the parameters defined by the clinician. The computer further includes the trajectory generator 1304 and the trajectory validator 1306 adapted to process the received parameters and send instructions to the motor control unit 1308. The motor control unit 1308 is connected to each actuators (808a, 808b, 810a, 810b, 812a, 812b, 814a and 814b) of FIG. 8 when in horizontal configuration or actuators (108a, 108b, 108c and 108d) of FIG. 1 when in vertical configuration in order to control the actuators according to the parameters defined by the clinician. It shall be recognized that the trajectory generator 1304 can already have a predetermined set of rehabilitation exercises that the clinician can select via the user interface 1302.

According to one embodiment, the user interface 1302 is adapted to allow a clinician to input patient morphology parameters and to input exercise parameters such as a target limb portion, an amplitude, an angle, a speed and a number of cycles.

According to yet another embodiment, the user interface 1302 is adapted to allow a clinician to input patient morphology parameters and select a predefined exercise.

According to yet another embodiment, the user interface 1302 is adapted to allow a clinician to input patient morphology parameters, to input exercise parameters and to input patient articulatory restrictions. The trajectory validator 1306 is adapted to verify or modify the trajectory generated according to the patient morphology parameters and the patient articulatory restrictions.

### Kit for Assembling a Limb Rehabilitation Device

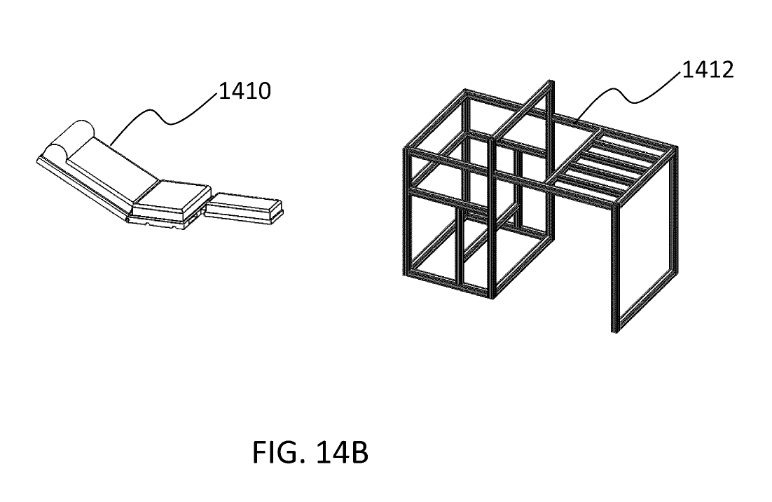

Presented in FIG. 14A is a kit 1400 for assembling a limb rehabilitation device 1302, according to one embodiment. The kit includes at least one platform 1402, a plurality of cables 1404, a plurality of actuators 1406 and a plurality of pulleys 1408. The platform 1402 is adapted to receive and support at least a portion of a limb of the patient. The cables 1404 are adapted to connect to the platform 1402 as presented by assembly 1407. The actuators 1406 are adapted to drive the cables 1404. The pulleys 1408 are adapted to guide the cables 1404.

In one embodiment, the kit 1400 further includes an upper body support 1410 and a frame 1412, as presented in FIG. 14B. The upper body support 1410 is adapted to support an upper body of the patient particularly when performing exercises in the supine position. The frame 1412 is adapted to mount thereon the actuators 1406 and the plurality of pulleys 1408.

The cable-driven robot 100 of FIGS. 1 and 8 for rehabilitation of the lower-limb in a vertical or horizontal position presents interesting advantages when compared to other currently available robotic devices. The cable-driven robot 100 offers amongst other the possibility of performing both open chain (where the foot is free to move, such as a leg extension) and closed chain muscular exercises (where the foot is fixed in space, such as a lunge). Moreover, the robot 100 is easily reconfigured and can be adapted to different types of lower-limb exercises. According to one embodiment, the robot 100 is reconfigurable by simply displacing the cable guides or pulleys (302a to 302d) and is adapted to provide rehabilitation of the lower-limb in vertical as well as horizontal positions.

Additionally, since the robot 100 is actuated by a cable system, it has the flexibility to absorb various secondary limb movements from the patient. Also, the robot 100 architecture and components are light and economical to produce.

A skilled person shall understand that the platform 102 or 802 can have any suitable shape or form without departing from the cable-robot. For instance, the platform 102 or 802 can have only the lower-leg segment in order to receive only a lower-leg of a patient. Moreover, the platform 102 or 802 can have an additional segment in order to receive an upper-leg of a patient.

Although the cable-robot 100 is described as being suitable for rehabilitating a lower limb, it shall be understood that the cable-robot 100 can also be used for rehabilitating other parts of the human body related to an upper limb region, a trunk region, etc. Moreover, the cable-robot 100 can also be suitable for rehabilitating limbs of various types of animals.

A skilled person would understand that although the cable-robot described herein has actuators that are motors adapted to wind or unwind an associated cable, other variations of actuators that are capable of extending or retracting a cable length are possible without departing from the present cable-robot. Moreover, it shall further be understood by the skilled person that the cable can be replaced by any other suitable type of link such as a cord, chain, wire, etc. that can be controllably retracted or extended.

It shall further be understood that the rehabilitation protocol is not only restricted to a locomotor rehabilitation protocol but could also include other types of rehabilitation protocols such as a neurological rehabilitation protocol. Moreover, the rehabilitation protocol can provide a lower limb recovery therapy, a lower limb strengthening therapy, a lower limb locomotor therapy or any other suitable type of therapy.

The embodiments of the invention described above are intended to be exemplary only. The scope of the invention is therefore intended to be limited solely by the scope of the appended claims.

1. A limb rehabilitation device comprising:
a platform for receiving thereon at least a portion of a limb of a patient, the platform having at least three fixed cable positioning attachments;
a frame;
at least three cables, each of the at least three cables having a platform connection end and an opposite actuator end, each of the at least three cables being directly connected to a corresponding one of the at least three fixed cable positioning attachments of the platform at the platform connection end; and
at least three actuators each mounted to the frame, each of the at least three actuators being adapted to extend or retract a corresponding one of the at least three cables from the actuator end in a straight line between the platform connection end and the actuator end and provide at least three degrees of freedom movement to the platform, according to a rehabilitation protocol.

2. The limb rehabilitation device of claim 1, wherein the platform comprises a lower leg segment and a foot segment, the lower leg segment being adapted to receive thereon a lower leg of the patient and the foot segment being adapted to receive thereon a foot of the patient.

3. The limb rehabilitation device of claim 2, wherein the lower leg segment and the foot segment are pivotally joined.

4. The limb rehabilitation device of any one of claims 1 to 3, further comprising a plurality of guides mounted on the frame, each of the plurality of guides being adapted to redirect a respective one of the at least three cables, between the actuator end and the platform connection end.

5. The limb rehabilitation device of claim 4, wherein the plurality of guides are repositionable on the frame in order to provide movement to the platform for a supine position configuration as well as a standing position configuration without having to reposition the at least three actuators.

6. The limb rehabilitation device of any one of claims 1 to 5, further comprising a table positioned to support an upper body portion of the patient lying in a supine position and while the platform has received thereon the at least portion of the limb.

7. A method of controlling a limb rehabilitation device, the method comprising:
receiving a patient morphology parameter;
receiving an exercise command parameter according to a rehabilitation protocol;
determining a trajectory according to the patient morphology parameter and the exercise command parameter;
controlling an actuation system according to the trajectory;
suspending the platform with at least three controllable links in order to provide at least three degrees of freedom to the platform;
actuating by extending or retracting at least one of the at least three controllable links according to the controlling; and
displacing at least one portion of the platform according to the actuating.

8. The method of claim 7 wherein the at least one controllable link is connected to the platform at a single fixed connection attachment of the platform.

9. The method of any one of claims 7 and 8 further comprising supporting a patient limb with the platform.

10. The method of claim 9 wherein the supporting is continuous along at least one longitudinal portion of the patient limb.

11. The method of any one of claims 7 to 10 wherein the platform comprises a plurality of segments that are pivotally joined.

12. The method of claim 11 wherein the trajectory is indicative of a displacement of a single one of the plurality of segments.

13. The method of any one of claims 7 to 12 wherein the trajectory is indicative of a rotational movement of the platform.

14. The method of any one of claims 7 to 13 further comprising validating the trajectory according to the patient morphology parameters and the exercise command parameters.

15. The method of any one of claims 7 to 14 further comprising displacing guides associated to the at least three controllable links in order to reconfigure the limb rehabilitation device from a supine position to a vertical position.

16. The method of any one of claims 7 to 15 wherein the rehabilitation protocol comprises supporting at least one part of the lower limb and produce an articulatory movement in one of a hip joint, a knee joint and an ankle joint, in order to provide lower limb recovery therapy.

17. The method of any one of claims 7 to 16 wherein the rehabilitation protocol comprises supporting at least one part of the lower limb and produce an articulatory movement in one of a hip joint, a knee joint and an ankle joint, in order to provide a lower limb strengthening therapy.

18. A limb rehabilitation device kit comprising:
a longitudinal platform adapted to receive and support at least a portion of a limb, the longitudinal platform having at least three fixed cable positioning attachments
at least three cables adapted to connect to one of the at least three fixed cable positioning attachments of the longitudinal platform; and
at least three actuators adapted to drive the at least three cables.

19. The limb rehabilitation device kit of claim 18 wherein the longitudinal platform comprises a plurality of segments.

20. The limb rehabilitation device kit of claim 19 wherein the longitudinal platform further comprises at least one joint adapted to pivotally join the plurality of segments.
